(19) United States
(12) Patent Application Publication
(10) Pub. No.: US 2020/0020090 A1
(43) Pub. Date: Jan. 16, 2020

(54) 3D Moving Object Point Cloud Refinement Using Temporal Inconsistencies

(71) Applicant: INTEL CORPORATION, Santa Clara, CA (US)

(72) Inventors: Alon Pukach, Tel Aviv (IL); Tzachi Hershkovich, Kefar Rut (IL); Pavel Kozlov, Tel Aviv (IL)

(73) Assignee: INTEL CORPORATION, Santa Clara, CA (US)

(21) Appl. No.: 16/583,787

(22) Filed: Sep. 26, 2019

Related U.S. Application Data
(60) Provisional application No. 62/881,141, filed on Jul. 31, 2019.

(51) Int. Cl. G06T 5/50; H04N 13/243; G06T 7/246; G06T 5/00; G06T 7/90; H04N 13/282; G06K 9/62

(52) U.S. Cl. CPC G06T 5/50; H04N 13/243; G06T 7/248; G06T 5/005; G06T 2207/10024; H04N 13/282; G06K 9/6215; G06K 9/6202; G06T 2207/10028; G06T 7/90

(57) ABSTRACT

A method for 3D moving object point cloud refinement using temporal inconsistencies is described herein. The method includes extracting a descriptor for each 3D seed point from a plurality of images captured via a plurality of cameras in a camera configuration and determining a similarity score for each 3D seed point according to temporal inconsistencies in the extracted descriptor. The method also includes removing false positive 3D seed points via a classifier.

### CROSS REFERENCE TO RELATED APPLICATIONS

The present application claims the benefit of the filing date of U.S. Provisional Patent Application No. 62/881,141, filed Jul. 31, 2019, which is incorporated herein by reference.

### BACKGROUND

Multiple cameras are used to capture activity in a scene. The multiple cameras may be used to enable volumetric capture, where a scene is recorded from a plurality of viewpoints. The captured images may be processed to create high quality three-dimensional models for volumetric content. In particular, a three-dimensional point cloud may be estimated during three-dimensional scene capture.

### BRIEF DESCRIPTION OF THE DRAWINGS

FIG. 1 is an illustration of projections of multiple three-dimensional (3D) points on two reference images;

FIG. 2 is a system that enables 3D moving object point cloud refinement using temporal inconsistencies;

FIG. 3 is a process flow diagram of a method determining multiple-view temporal inconsistency;

FIG. 4 illustrates a single seed feature vector;

FIG. 5 is a block diagram of a method that enables 3D moving object point cloud refinement using temporal inconsistencies;

FIG. 6 is a block diagram illustrating 3D moving object point cloud refinement using temporal inconsistencies; and

FIG. 7 is a block diagram showing computer readable media that stores code for 3D moving object point cloud refinement using temporal inconsistencies.

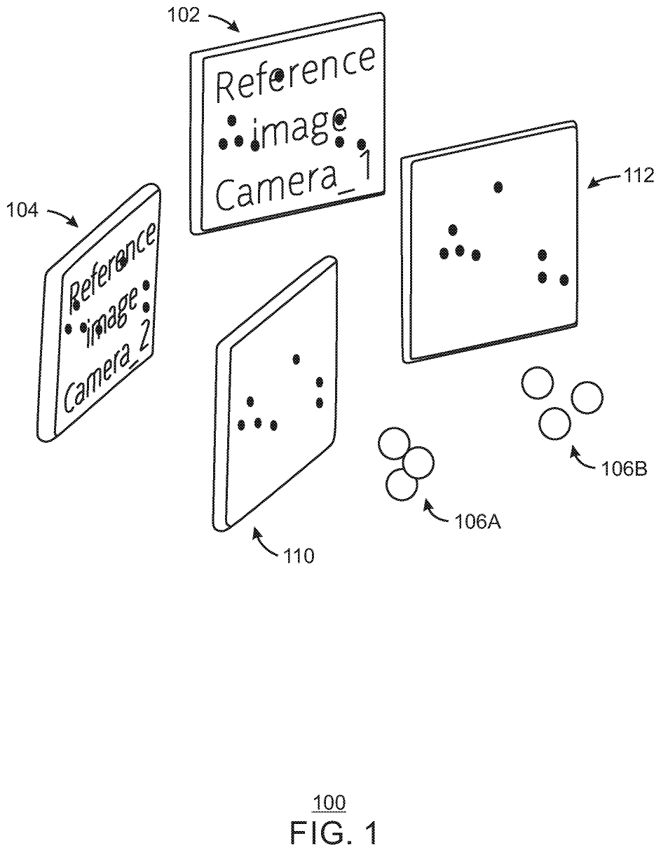

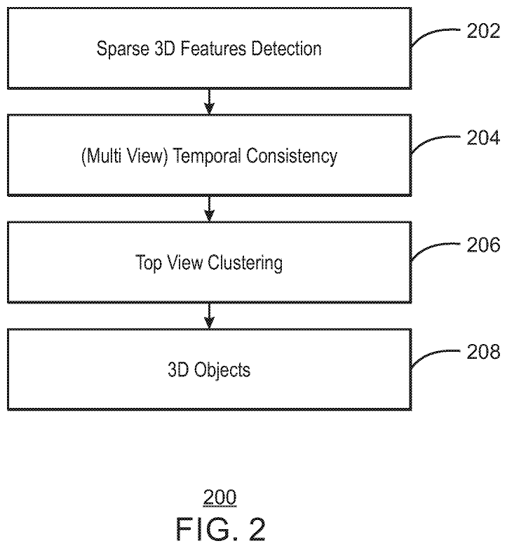

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Generally, a point cloud is a set of data points within a space, where each point can be specified by one or more coordinates. For example, in a three-dimensional (3D) space, each point may be specified by three values or coordinates. Typically, 3D point cloud estimation techniques rely on color consistencies between multiple-views as captured by multiple cameras. When video content is available, temporal statistics may be collected using various tracking or motion estimators. To derive temporal statistics, objects may be reconstructed in each frame, and the motion of the object is estimated from frame to frame. However, typical 3D point cloud estimation does not yield a high quality, accurate 3D scene. Indeed, the traditional 3D point cloud estimation is filled with errors, leading to a low-quality inaccurate scene. Moreover, the low-quality inaccurate 3D scene may be the result of capturing system limitations, a lack of multiple-view information, and limited computational power.

The present techniques enable a 3D moving object point cloud refinement using temporal inconsistencies. During point cloud refinement according to the present techniques, spatio-temporal information may be obtained from multiple video streams. The behavior of static objects over time is leveraged along with and each object's relation to fast moving objects in the general scene. In particular, static objects are defined as a part of the background region of the scene. Portions of the 3D point cloud that correspond to the static objects will exhibit high temporal consistencies, and can be filtered out or removed from the scene as background points. In embodiments, a field of play may be captured by multiple cameras using a volumetric capture process.

FIG. 1 is an illustration of projections 100 of multiple 3D points on two reference images 102 and 104. In particular, the reference image 102 may be captured by a first camera, and the reference image 104 may be captured by a second camera. For ease of description and illustration, only two reference images as captured by two cameras are illustrated. However, any number of cameras may be used. In embodiments, a number of cameras may be used to capture a scene that includes field of play. For example, multiple cameras may be deployed in a stadium to capture high-resolution images of a field of play during a game. The multiple cameras may be configured in a static layout. Specifically, each camera of the multiple cameras may have a static location and orientation in the multiple camera configuration.

Images captured by the plurality of cameras may be segmented into a foreground region and a background region. Generally, objects that are moving are labeled as belonging to the foreground region while objects that are static are labeled as belonging to the background region. Data points corresponding to the static objects and moving objects may be included in the reference images 102 and 104. In this scenario, only static objects will exhibit a high temporal consistency across a sequence of frames. In embodiments, the reference images 102 and 104 may include mostly pixels labeled as belonging to the background region. Moreover, in embodiments the reference images 102 and 104 may be derived from a sequence of images captured by each respective camera. Additionally, in embodiments the reference images 102 and 104 may be captured at a particular time.

The point cloud refinement as described herein projects 3D points from a point cloud that correspond to 3D points of moving objects in the scene onto the reference images. Thus, data corresponding to moving, foreground objects are projected onto the reference images. As illustrated in FIG. 1, the two sets of points 106A and 1068 represent points from a 3D point cloud. Further, the set of points 106A and the set of points 1068 may represent moving objects labeled as the foreground in the scene. In embodiments, the points 106A and 106B may be 3D seeds, where a 3D seed is one or more points of interest found in a plurality of images as captured by the multiple-view camera configuration. Accordingly, multiple-views of the 3D seeds are captured by the multiple-view camera configuration. The points 106A and 1068 are projected via a projection 110 and a projection 112. As illustrated, each of the points 106A and 1068 are projected onto the reference image 102. Additionally, each of the points 106A and 1068 are projected onto the reference image 104.

In embodiments, the 3D model according to the present techniques projects 3D points of moving objects (foreground) at time t onto static objects (background) using images from multiple cameras at time t-T, where T is a positive scalar which represents a certain period of time. The value of T may be selected such that the images at time t-T minimize differences in lightning conditions, differences in the static objects, and an amount of moving objects across the reference images to obtain a high quality refinement of the point cloud. Accordingly, the higher the quality of the reference images at time t-T, the higher the quality of the point cloud refinement according to the present techniques. The value of T is selected to minimize differences in lightning conditions, differences in the static objects, and an amount of moving objects in the reference images from each camera.

In embodiments, two-dimensional (2D) points of interest may be found in each projection. The 2D projected points in the projection 112 and the projection 114 may be used to create a descriptor. The descriptor may be used to determine a similarity between each 2D projected point, such as the points in the projection 112 and the projection 114, and the same projected point in the respective reference image. The similarity may be represented by a similarity score. The similarity measure across all cameras is used as a feature vector of the corresponding 3D point from the point cloud. Machine learning may be applied to the similarity scores to determine if the 3D point is a false positive or a true positive. In this manner, data points in the point cloud that are false positives can be removed from the point cloud, resulting in point cloud refinement according to temporal inconsistencies.

The diagram of FIG. 1 is not intended to indicate that the example projections are limited to the particular type of projections illustrated in FIG. 1. Rather, the example projections can be of any number, as captured from any number of cameras. Moreover, the present techniques are not limited to any particular sport or game.

Traditionally, most 3D model estimation and point cloud refinement techniques are limited to the use of photometric consistency between different images. Traditionally, temporal information is not used in 3D model estimation or point cloud refinement. When temporal information is used, the temporal information is usually incorporated via different tracking and motion estimation approaches in order to collect color information. This results in temporal consistency being based on spatial photo-consistency.

However, traditional spatial photo-consistency is prone to errors in a highly occluded scene and when spatial statistics are poor. Spatial statistics may be poor, for example, when a small number of multiple-view cameras are available. Further, a scene may often be highly occluded during sports games, where a ball or other object is used for game play, or when players tend to congregate in the same area during play. Traditionally, when temporal features are used on moving objects, motion estimators tend to fail in scenarios of large displacements, occlusions and non-linear movements. In addition, dense motion estimators are insensitive to small object movement and smooth out the motion of small objects, resulting in a loss of small object movement in a series of images.

The present techniques determine inconsistencies in point cloud projection colors between two (or more) time frames across multiple cameras from multiple-views. In embodiments, 3D points of moving objects are considered the foreground, while static objects are considered the back ground. The 3D points of moving objects (foreground) at time t will be projected onto static objects (background) using images from time t-T, where T is a positive scalar which represents a certain period of time. The present techniques are highly efficient in a non-moving camera layout and can create high quality 3D models for volumetric content. Temporal refinement as suggested here is the basis for a robust feature-based framework for object detection that is described in FIG. 2.

In embodiments, the present techniques may be applied to scenes that include sporting events or games. The sporting event may be captured via a volumetric capture method, with footage captured by a plurality of cameras. The 5K ultra-high-definition cameras that capture height, width and depth data to produce voxels (pixels with volume). Thus, a camera configuration according to the present techniques may include multiple super-high-resolution cameras to capture the entire playing area. After the game content is captured, a substantial amount of data is processed, where all the viewpoints of a fully volumetric three-dimensional person or object are recreated. This information may be used to render a virtual environment in a multi-perspective three-dimensional format that enables users to experience a captured scene from any angle and perspective and can provide true six degrees of freedom within the virtual environment.

In embodiments, the captured scene may be a field of play as used in a competitive sport. As used herein, a game may refer to a form of play according to a set of rules. The game may be played for recreation, entertainment, or achievement. A competitive game may be referred to as a sport, sporting event, or competition. Accordingly, a sport may also be a form of competitive physical activity. The game may have an audience of spectators that observe the game. The spectators may be referred to as end-users when the spectators observe the game via an electronic device, as opposed to viewing the game live and in person. The game may be competitive in nature and organized such that opposing individuals or teams compete to win. Often, the game is played on a field, court, within an arena, or some other area designated for game play. The area designated for game play may be captured using a camera configuration or system as described herein. The area designated for game play typically includes markings, goal posts, nets, and the like to facilitate game play. In embodiments, the markings, goal posts, nets, and the like to facilitate game play may be considered background, static elements of a captured image.

FIG. 2 is a block diagram of a system 200 that enables a 3D moving object point cloud refinement using temporal inconsistencies. In particular, the present techniques enable a multiple-view feature-based object detection which uses the spatial-temporal point cloud refinement as described herein. As used herein, a temporal inconsistency may refer to a data point that is temporarily inconsistent across multiple images from multiple cameras. For example, at a time slice T, a data point may be found in a first frame or image that is an outlier. This outlier may not be present in other frames or images of the scene at the same time slice T. In this example, the data points found in one frame but not others may be considered temporally inconsistent. In embodiments, temporal inconsistent data points may have different color values for the same point across a plurality of frames.

At block 202, sparse 3D feature detection occurs. In the sparse 3D feature detection, a sparse point cloud may be generated. Each point in the point cloud has color information, location information, and depth data. The color information may be RGB data. The location information may be 3D coordinate data. Sparse 3D feature detection may begin by capturing multiple images of a scene, and detecting points of interest within every image. The points of interest with a first time stamp from one or more cameras may be matched with other images at another time stamp from the one or more cameras. These points of interest are matched from the first time stamp to the another time stamp. The matching or corresponding points of interest are used to derive a 3D point in space. The 3D point may also include color information that corresponds to the 3D point. In embodiments, the color information may be red, green, blue (RBG) data. As discussed above, the data points may be referred to as a point cloud. A point cloud may have millions of points. Matching points of interest may occur across a large number of points. The point cloud may be refined over time by updating the points of interest as additional data is captured. The points derived from matching may be referred to as a sparse point cloud, and can include a number of features. The sparse point cloud may be used to derive a dense point cloud or a mesh. The present techniques enable temporal refinement of the point cloud by removing false positives derived from temporal inconsistencies, where a false positive is a point in the point cloud that contains erroneous or false information.

At block 204, multiple-view temporal consistencies are determined. To determine multiple-view temporal consistency, for multiple views the points that are consistent across multiple cameras at certain time stamps are determined. In some cases, points may be matched between views using a scale-invariant feature transform (SIFT) descriptor given a sparse 3D point-cloud and camera extrinsic information for each time stamp. In this example, these features are matched temporally using the SIFT descriptor to identify the moving points. Other sparse feature matching techniques may be used to match captured 3D features to determine temporal consistency between features. Sparse feature matching techniques include, but are not limited to, applying a nearest neighbor search or ratio test to feature representations defined using SIFT, speeded up robust features (SURF), or any combination thereof.

At block 206, top view clustering is performed. In top view clustering, an unsupervised clustering technique may be executed to determine clusters within the point cloud. Determining clusters within the point cloud may be done using any number of techniques, such as determining the Euclidean distances of SIFT descriptors or a nearest neighbor classifier. In this manner, the sparse point cloud points may be clustered. At block 208, 3D objects are obtained. In particular, the 3D objects may be located within the clusters derived from the point cloud. In embodiments, each cluster represents an object in the foreground region of the image. Additional processing may be applied to the derived 3D objects, including but not limited to cleanup, dense point cloud generation, mesh creation, smoothing, and optimization.

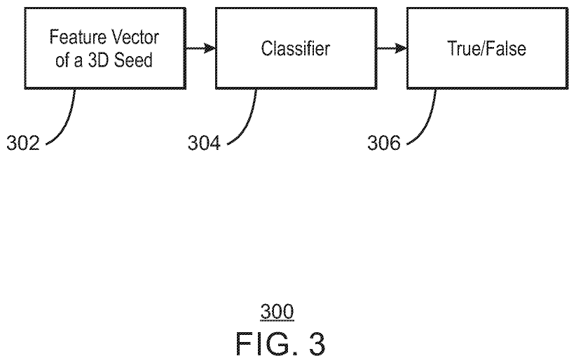

FIG. 3 is a process flow diagram of a method 300 for determining multiple-view temporal inconsistency. The method 300 may be, for example, executed at block 204 of FIG. 2. A determination of temporally consistent points in a 3D point cloud may also determine temporally inconsistent points within the same 3D point cloud. In embodiments, the present techniques enable a multiple-view feature based method for object detection which uses the techniques as described herein for spatio-temporal point cloud refinement. Generally, descriptors may be extracted from current image frames at time t. Descriptors may also be extracted from the reference images that correspond to the current image frames at time t. A bag of features is created for a number of 3D seed points based on the descriptors, and falsely detected 3D points are removed or eliminated from the 3D point cloud.

Accordingly, at block 302, a feature vector of a 3D seed is determined. The feature vector is derived for the current frames at time t. The feature vector describes characteristics of the 3D seed across all current frames at time t. In particular, each x, y, z coordinate feature for each 3D seed is projected onto each of the reference images. Each reference image corresponds to a particular camera and camera view. For each 2D projected point, a descriptor based on image colors and a gradients map may be created. In particular, the descriptor defines color and gradient information for each 2D projected point. In embodiments, the descriptor may transform each 2D projected point into a feature vector. The descriptor may be, for example, a Histogram of Gradients (HoG) descriptor. In the HoG descriptor, histograms of directions of gradients may be used to derive features for each 2D projected point. Each gradient may include a magnitude and a direction, and each gradient may be determined with respect to each color channel. For ease of description, the present techniques are described using the HoG descriptor. However, any descriptor may be used. Put another way, the descriptor type is not limited. Additionally, descriptors may be extracted for 2D projected points on each of the reference images.

At block 304, a classifier is executed. The classifier may be, for example, a supervised machine learning classifier that predicts if the projected points are consistent or inconsistent across the current frames at time t. The classifier may be pre-trained using labeled samples. In embodiments, the classifier may be used to create a bag of features for each 3D seed point. In embodiments, the bag of features includes a vector for each 2D projection point that comprises an occurrence count of image features as described by the descriptor. In embodiments, the bag of features may be initially extracted from a training data set to determine a visual vocabulary from the extracted features. In embodiments, clustering may be used to determine the bag of features. Clustering includes, but is not limited to, k-means and expectation-maximization (EM) clustering. In embodiments, the clustered image may be represented by a histogram of features assigned to each cluster.

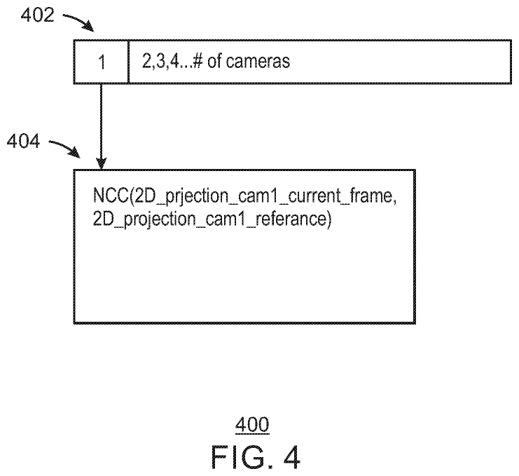

In embodiments, to create the bag of features, a similarity score is calculated. The similarity score is a measure of the similarity between each 2D projection point from the current frames at time t with the same 2D projection at in the reference frames at time t-T. Similarity is determined based on the generated descriptors. For example, similarity may be calculated using normalized cross correlation (NCC) as similarity measure and HoG as descriptor. FIG. 4 is an illustration of this example. In particular, as illustrated in the example of FIG. 4 normalized cross correlation is applied to a single 3D seed feature vector 402. In FIG. 4, the 3D seed feature vector 402 includes a HoG descriptor of the 2D projected point that corresponds to a 3D coordinate of the captured scene. Normalized cross correlation 404 is applied to the 3D seed feature vector 402. In the example of FIG. 4, the normalized cross correlation 404 is applied to a 2D projection from a current frame from a camera at time t-T and a 2D projection from a reference frame from the same camera at time t-T. In particular, the 2D projection points are normalized by calculating the dot product of the single seed feature vector and a reference frame feature vector divided the inner product of the single seed feature vector and a reference frame feature vector. The result of normalized cross correlation is a score with a value between −1 and 1. For ease of description, normalized cross correlation is described, however any matching techniques may be used.

Referring again to FIG. 3, at block 306, false positives are determined based on the score from the classifier 304. In embodiments, the score is a similarity score. Falsely detected 3D points are determined for all detected 3D seed points. In embodiments, the bag of features may be processed as a feature vector which describes each 3D seed. If the similarity score is greater than a predetermined threshold, then the corresponding 3D seed may be considered a false positive and removed from the point cloud. If the similarity score is less than the predetermined threshold, then the corresponding 3D seed is not considered a false positive and is not removed from the point cloud.

The present techniques go beyond the use temporal knowledge to track a specific object key points or either use photometric consistencies to refine a (static) 3D object point cloud. The present techniques enable the unique usage of the temporal inconsistency in a multiple-view static cameras.

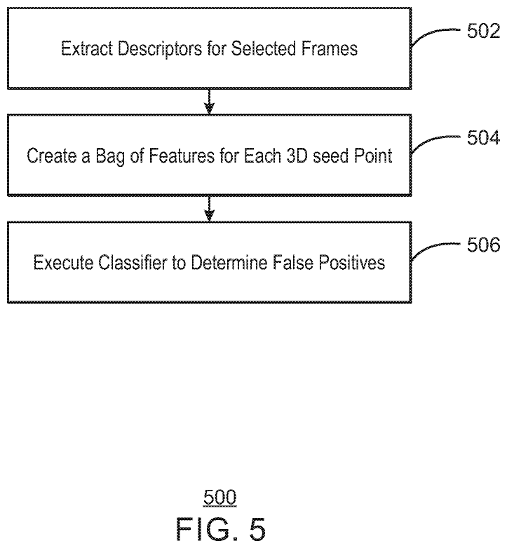

FIG. 5 is a block diagram of a method 500 that enables 3D moving object point cloud refinement using temporal inconsistencies. At block 502, a descriptor may be extracted from the plurality of captured images. In particular the descriptors may be extracted from projected point cloud data for the foreground objects in each frame or captured image at a particular time.

At block 504, a similarity score is determined. In embodiments, the similarity score may be determined via a similarity detector. The similarity score may be derived by creating a bag of features for each 3D seed point. At block 506, false positives are determined. As described herein, false positives may be 3D points that are temporally consistent and not inconsistent. Accordingly, if the similarity score is above a pre-determined threshold, the corresponding point may be considered a false positive. If the similarity score is below the predetermined threshold, the corresponding point may not be considered a false positive.

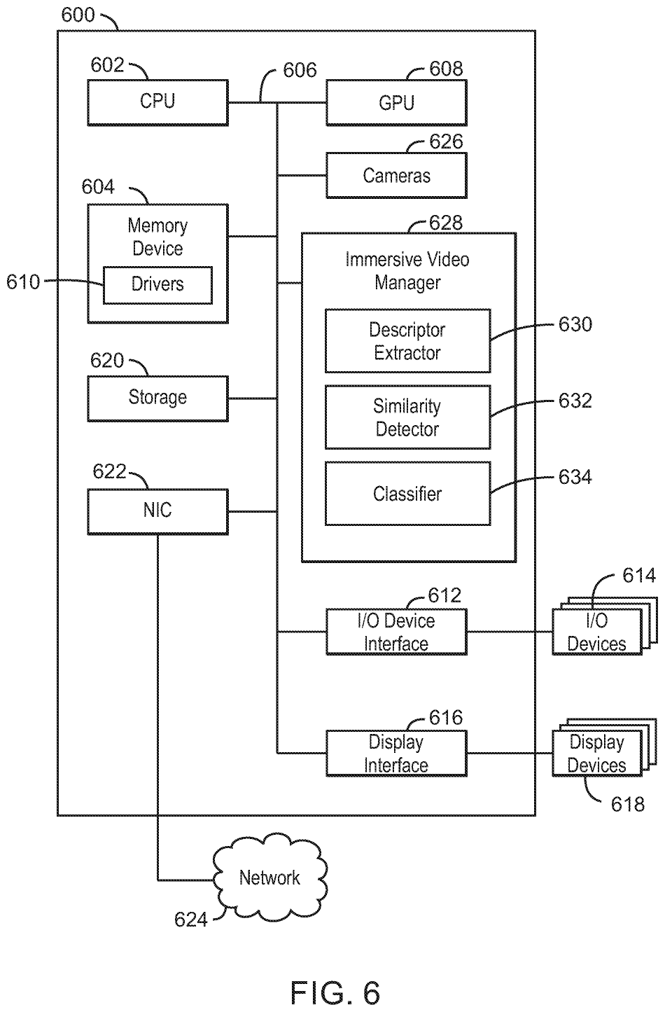

Referring now to FIG. 6, a block diagram is shown illustrating 3D moving object point cloud refinement using temporal inconsistencies. The computing device 600 may be, for example, a laptop computer, desktop computer, tablet computer, mobile device, or wearable device, among others. The computing device 600 may include a central processing unit (CPU) 602 that is configured to execute stored instructions, as well as a memory device 604 that stores instructions that are executable by the CPU 602. The CPU 602 may be coupled to the memory device 604 by a bus 606. Additionally, the CPU 602 can be a single core processor, a multi-core processor, a computing cluster, or any number of other configurations. Furthermore, the computing device 600 may include more than one CPU 602. In some examples, the CPU 602 may be a system-on-chip (SoC) with a multi-core processor architecture. In some examples, the CPU 602 can be a specialized digital signal processor (DSP) used for image processing. The memory device 604 can include random access memory (RAM), read only memory (ROM), flash memory, or any other suitable memory systems. For example, the memory device 604 may include dynamic random-access memory (DRAM).

The computing device 600 may also include a graphics processing unit (GPU) 608. As shown, the CPU 602 may be coupled through the bus 606 to the GPU 608. The GPU 608 may be configured to perform any number of graphics operations within the computing device 600. For example, the GPU 608 may be configured to render or manipulate graphics images, graphics frames, videos, or the like, to be displayed to a viewer of the computing device 600.

The CPU 602 may also be connected through the bus 606 to an input/output (I/O) device interface 612 configured to connect the computing device 600 to one or more I/O devices 614. The I/O devices 614 may include, for example, a keyboard and a pointing device, wherein the pointing device may include a touchpad or a touchscreen, among others. The I/O devices 614 may be built-in components of the computing device 600, or may be devices that are externally connected to the computing device 600. In some examples, the memory 604 may be communicatively coupled to I/O devices 614 through direct memory access (DMA).

The CPU 602 may also be linked through the bus 606 to a display interface 616 configured to connect the computing device 600 to a display device 616. The display devices 618 may include a display screen that is a built-in component of the computing device 600. The display devices 618 may also include a computer monitor, television, or projector, among others, that is internal to or externally connected to the computing device 600. The display device 616 may also include a head mounted display.

The computing device 600 also includes a storage device 620. The storage device 620 is a physical memory such as a hard drive, an optical drive, a thumbdrive, an array of drives, a solid-state drive, or any combinations thereof. The storage device 620 may also include remote storage drives.

The computing device 600 may also include a network interface controller (NIC) 622. The NIC 622 may be configured to connect the computing device 600 through the bus 606 to a network 624. The network 624 may be a wide area network (WAN), local area network (LAN), or the Internet, among others. In some examples, the device may communicate with other devices through a wireless technology. For example, the device may communicate with other devices via a wireless local area network connection. In some examples, the device may connect and communicate with other devices via Bluetooth® or similar technology.

The computing device 600 further includes an immersive viewing manager 628. The immersive video manager 628 may be configured to enable a 360° view of an event from any angle. In particular images captured by a plurality of cameras may be processed such that an end user can virtually experience any location within the field of play. Temporal inconsistency among point clouds may be used to remove falsely detected points. The immersive video manager 628 includes a descriptor extractor 630 to extract one or more descriptors from a plurality of captured images. A similarity detector may be configured to determine a similarity score between each 2D projection point from T with the same 2D projection at time t-T (based on the generated descriptors). A classifier 634 may be used to determine false positives in the 3D seed points.

The block diagram of FIG. 6 is not intended to indicate that the computing device 600 is to include all of the components shown in FIG. 6. Rather, the computing device 600 can include fewer or additional components not illustrated in FIG. 6, such as additional buffers, additional processors, and the like. The computing device 600 may include any number of additional components not shown in FIG. 6, depending on the details of the specific implementation. Furthermore, any of the functionalities of the immersive video manager 628, descriptor extractor 630, similarity detector 632, and classifier 634 may be partially, or entirely, implemented in hardware and/or in the processor 602. For example, the functionality may be implemented with an application specific integrated circuit, in logic implemented in the processor 602, or in any other device. For example, the functionality of the immersive video manager 628 may be implemented with an application specific integrated circuit, in logic implemented in a processor, in logic implemented in a specialized graphics processing unit such as the GPU 608, or in any other device.

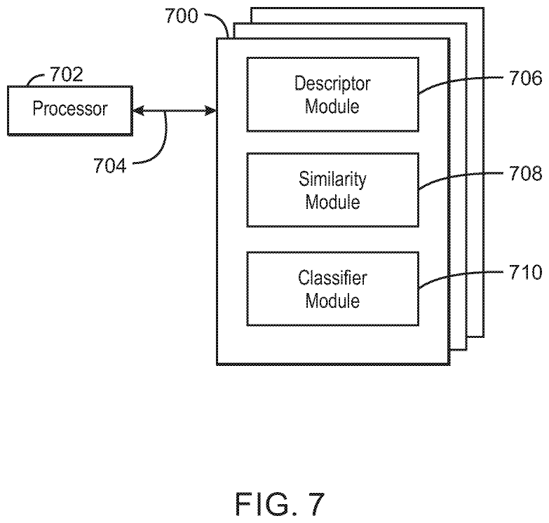

FIG. 7 is a block diagram showing computer readable media 700 that stores code for 3D moving object point cloud refinement using temporal inconsistencies. The computer readable media 700 may be accessed by a processor 702 over a computer bus 704. Furthermore, the computer readable medium 700 may include code configured to direct the processor 702 to perform the methods described herein. In some embodiments, the computer readable media 700 may be non-transitory computer readable media. In some examples, the computer readable media 700 may be storage media.

The various software components discussed herein may be stored on one or more computer readable media 700, as indicated in FIG. 7. For example, a descriptor module 706 may be configured to extract one or more descriptors from a plurality of captured images. A similarity module 708 may be configured to determine a similarity score between each 2D projection point from T with the same 2D projection at time t-T (based on the generated descriptors). A classifier module 710 may be used to determine false positives in the 3D seed points.

The block diagram of FIG. 7 is not intended to indicate that the computer readable media 700 is to include all of the components shown in FIG. 7. Further, the computer readable media 700 may include any number of additional components not shown in FIG. 7, depending on the details of the specific implementation.

### Examples

Example 1 is a method for three dimensional (3D) moving object point cloud refinement using temporal inconsistencies. The method includes extracting a descriptor for each 3D seed point from a plurality of images captured via a plurality of cameras in a camera configuration; determining a similarity score for each 3D seed point according to temporal inconsistencies in the extracted descriptor; and removing false positive 3D seed points via a classifier.

Example 2 includes the method of example 1, including or excluding optional features. In this example, extracted descriptor is based on image colors and a gradient map for a plurality of two dimensional (2D) projected points for each camera of the camera configuration. Optionally, each 2D projected point is derived from a projection of a 3D seed onto a reference image.

Example 3 includes the method of any one of examples 1 to 2, including or excluding optional features. In this example, the similarity score is determined via normalized cross correlation applied to feature vectors derived from the descriptor.

Example 4 includes the method of any one of examples 1 to 3, including or excluding optional features. In this example, the similarity score is determined via a bag of features for each 3D seed point.

Example 5 includes the method of any one of examples 1 to 4, including or excluding optional features. In this example, false positives are determined via the classifier using a threshold and logic regression.

Example 6 includes the method of any one of examples 1 to 5, including or excluding optional features. In this example, extracting the descriptor comprises: projecting each 3D seed onto a corresponding reference image; and generating a descriptor based on image colors and a gradients map.

Example 7 includes the method of any one of examples 1 to 6, including or excluding optional features. In this example, the method includes generating a descriptor for 2D projected points from each 3D seed and the corresponding points in the reference image; creating a bag of features for each 3D seed point; and determining the false positives via a feature vector based on the bag of features.

Example 8 includes the method of any one of examples 1 to 7, including or excluding optional features. In this example, the temporal inconsistencies are inconsistencies in point cloud projection colors.

Example 9 includes the method of any one of examples 1 to 8, including or excluding optional features. In this example, method of claim 1, where each camera of the camera configuration is at a static location and orientation.

Example 10 is a system for 3D moving object point cloud refinement using temporal inconsistencies. The system includes a descriptor extractor to extract a descriptor for each 3D seed point from a plurality of images captured via a plurality of cameras in a camera configuration; a similarity detector to determine a similarity score for each 3D seed point according to temporal inconsistencies in the extracted descriptor; and a classifier to remove false positive 3D seed points.

Example 11 includes the system of example 10, including or excluding optional features. In this example, extracted descriptor is based on image colors and a gradient map for a plurality of 2D projected points for each camera of the camera configuration. Optionally, each 2D projected point is derived from a projection of a 3D seed onto a reference image.

Example 12 includes the system of any one of examples 10 to 11, including or excluding optional features. In this example, the similarity score is determined via normalized cross correlation applied to feature vectors derived from the descriptor.

Example 13 includes the system of any one of examples 10 to 12, including or excluding optional features. In this example, the similarity score is determined via a bag of features for each 3D seed point.

Example 14 includes the system of any one of examples 10 to 13, including or excluding optional features. In this example, false positives are determined via the classifier using a threshold and logic regression.

Example 15 includes the system of any one of examples 10 to 14, including or excluding optional features. In this example, extracting the descriptor comprises: projecting each 3D seed onto a corresponding reference image; and generating a descriptor based on image colors and a gradients map.

Example 16 includes the system of any one of examples 10 to 15, including or excluding optional features. In this example, the system includes generating a descriptor for 2D projected points from each 3D seed and the corresponding points in the reference image; creating a bag of features for each 3D seed point; and determining the false positives via a feature vector based on the bag of features.

Example 17 includes the system of any one of examples 10 to 16, including or excluding optional features. In this example, the temporal inconsistencies are inconsistencies in point cloud projection colors.

Example 18 includes the system of any one of examples 10 to 17, including or excluding optional features. In this example, system of claim 11, where each camera of the camera configuration is at a static location and orientation.

Example 19 is at least one non-transitory computer-readable medium. The computer-readable medium includes instructions that direct the processor to extracting a descriptor for each 3D seed point from a plurality of images captured via a plurality of cameras in a camera configuration; determining a similarity score for each 3D seed point according to temporal inconsistencies in the extracted descriptor; and removing false positive 3D seed points via a classifier.

Example 20 includes the computer-readable medium of example 19, including or excluding optional features. In this example, extracted descriptor is based on image colors and a gradient map for a plurality of two dimensional (2D) projected points for each camera of the camera configuration. Optionally, each 2D projected point is derived from a projection of a 3D seed onto a reference image.

Example 21 includes the computer-readable medium of any one of examples 19 to 20, including or excluding optional features. In this example, the similarity score is determined via normalized cross correlation applied to feature vectors derived from the descriptor.

Example 22 includes the computer-readable medium of any one of examples 19 to 21, including or excluding optional features. In this example, the similarity score is determined via a bag of features for each 3D seed point.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more aspects. For instance, all optional features of the computing device described above may also be implemented with respect to either of the methods or the computer-readable medium described herein. Furthermore, although flow diagrams and/or state diagrams may have been used herein to describe aspects, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method for three dimensional (3D) moving object point cloud refinement using temporal inconsistencies, comprising:
extracting a descriptor for each 3D seed point from a plurality of images captured via a plurality of cameras in a camera configuration;
determining a similarity score for each 3D seed point according to temporal inconsistencies in the extracted descriptor; and
removing false positive 3D seed points via a classifier.

2. The method of claim 1, wherein extracted descriptor is based on image colors and a gradient map for a plurality of two dimensional (2D) projected points for each camera of the camera configuration.

3. The method of claim 2, wherein each 2D projected point is derived from a projection of a 3D seed onto a reference image.

4. The method of claim 1, wherein the similarity score is determined via normalized cross correlation applied to feature vectors derived from the descriptor.

5. The method of claim 1, wherein the similarity score is determined via a bag of features for each 3D seed point.

6. The method of claim 1, wherein false positives are determined via the classifier using a threshold and logic regression.

7. The method of claim 1, wherein extracting the descriptor comprises:
projecting each 3D seed onto a corresponding reference image; and
generating a descriptor based on image colors and a gradients map.

8. The method of claim 1, comprising:
generating a descriptor for 2D projected points from each 3D seed and the corresponding points in the reference image;
creating a bag of features for each 3D seed point; and
determining the false positives via a feature vector based on the bag of features.

9. The method of claim 1, wherein the temporal inconsistencies are inconsistencies in point cloud projection colors.

10. The method of claim 1, where each camera of the camera configuration is at a static location and orientation.

11. A system for 3D moving object point cloud refinement using temporal inconsistencies, comprising:
a descriptor extractor to extract a descriptor for each 3D seed point from a plurality of images captured via a plurality of cameras in a camera configuration;
a similarity detector to determine a similarity score for each 3D seed point according to temporal inconsistencies in the extracted descriptor; and
a classifier to remove false positive 3D seed points.

12. The system of claim 11, wherein extracted descriptor is based on image colors and a gradient map for a plurality of 2D projected points for each camera of the camera configuration.

13. The system of claim 12, wherein each 2D projected point is derived from a projection of a 3D seed onto a reference image.

14. The system of claim 11, wherein the similarity score is determined via normalized cross correlation applied to feature vectors derived from the descriptor.

15. The system of claim 11, wherein the similarity score is determined via a bag of features for each 3D seed point.

16. The system of claim 11, wherein false positives are determined via the classifier using a threshold and logic regression.

17. The system of claim 11, wherein extracting the descriptor comprises:
projecting each 3D seed onto a corresponding reference image; and
generating a descriptor based on image colors and a gradients map.

18. The system of claim 11, comprising:
generating a descriptor for 2D projected points from each 3D seed and the corresponding points in the reference image;
creating a bag of features for each 3D seed point; and
determining the false positives via a feature vector based on the bag of features.

19. The system of claim 11, wherein the temporal inconsistencies are inconsistencies in point cloud projection colors.

20. The system of claim 11, where each camera of the camera configuration is at a static location and orientation.

21. At least one non-transitory computer-readable medium, comprising instructions to direct a processor to:
extracting a descriptor for each 3D seed point from a plurality of images captured via a plurality of cameras in a camera configuration;
determining a similarity score for each 3D seed point according to temporal inconsistencies in the extracted descriptor; and
removing false positive 3D seed points via a classifier.

22. The computer-readable medium of claim 21, wherein extracted descriptor is based on image colors and a gradient map for a plurality of two dimensional (2D) projected points for each camera of the camera configuration.

23. The computer-readable medium of claim 22, wherein each 2D projected point is derived from a projection of a 3D seed onto a reference image.

24. The computer-readable medium of claim 21, wherein the similarity score is determined via normalized cross correlation applied to feature vectors derived from the descriptor.

25. The computer-readable medium of claim 21, wherein the similarity score is determined via a bag of features for each 3D seed point.
